(19) United States
(12) Patent Application Publication
(10) Pub. No.: US 2018/0144592 A1
(43) Pub. Date: May 24, 2018

(54) DEVICE AND METHOD FOR THEFT DETECTION

(71) Applicant: Robert Bosch GmbH, Stuttgart (DE)

(72) Inventors: Fernando Suarez Lainez, Reutlingen (DE); Frank Schindler, Reutlingen (DE)

(21) Appl. No.: 15/572,709

(22) PCT Filed: Apr. 18, 2016
(86) PCT No.: PCT/EP2016/058577

§ 371 Date: Nov. 8, 2017

(30) Foreign Application Priority Data
May 12, 2015 (DE) 10 2015 208 771.9

(51) Int. Cl. G08B 13/14

(52) U.S. Cl. CPC G08B 13/1436

(57) ABSTRACT

A device for theft recognition, having a processing unit, a communication unit that is at least set up to send out a first signal, and a first motion sensor realized as an acceleration sensor. The device further includes at least one second motion sensor. In addition, the processing unit is set up to acquire a respective first value at a first time, and to acquire a respective second value at a second time, from each motion sensor, to determine in each case a change between the first value and the second value of each motion sensor, and, after a change that exceeds a threshold value for the respective motion sensor, to control the communication unit in such a way that this unit sends out the first signal. In addition, a method for theft recognition using the device is also described.

### BACKGROUND INFORMATION

Movable objects are at risk of being stolen. It therefore makes sense to monitor such objects and to report any attempted theft. This is appropriate in particular for art objects. In order to prevent theft, there exist devices that can recognize an attempted theft and correspondingly trigger an alarm.

The present invention is based on a device for protection against theft, having a processing unit, having a communication unit that is set up at least to send out a first signal, and having a first motion sensor realized as an acceleration sensor.

Such a device is described, for example, in China Patent Application CN 104058030 A.

### SUMMARY

The present invention is based on a device for protection against theft, having a processing unit, having a communication unit that is set up at least to send out a first signal, and having a first motion sensor realized as an acceleration sensor. In accordance with the present invention, the device additionally has at least one second motion sensor. In addition, the processing unit is set up to acquire from each motion sensor a respective first value at a first time, and a respective second value at a second time. In addition, the processing unit is set up to determine a respective difference between the first value and the second value of each motion sensor. Moreover, the processing unit is set up to control the communication unit in such a way that it sends out the first signal after at least one change that exceeds a threshold value for the respective motion sensor.

Here it is advantageous that the at least one second motion sensor increases the probability that an attempted theft will be recognized. Thus, for example the first motion sensor can detect an acceleration in the three spatial directions, whereas the second motion sensor is realized as a gyro sensor that can detect a rotational motion. In this way, both a linear motion and a circular motion of the object to which the device according to the present invention is attached are recognized. Alternatively, the second motion sensor can also be realized as a magnetic field sensor or as a pressure sensor, or the device can have these two sensors as third and fourth motion sensor.

In an advantageous embodiment of the present invention, the processing unit is set up to receive, in particular via the communication unit, a second signal that signals the start of a training phase and a third signal that signals the start of a monitoring phase. Here, the first time is within the training phase and the second time is within the monitoring phase.

Here it is advantageous that via the second and third signal a training phase and a monitoring phase are recognized, so that it is thus possible to move from one to the other. In the training phase, the object being monitored is in a target state, and the first values of the sensors for this target state can then be acquired at the first time. In the monitoring phase, the second values of the sensors can be acquired at the second time and compared to the first values in order to check whether these second values are still in a range that approximates the target state. If this is the case, it can be assumed that there is no attempted theft.

According to an advantageous embodiment of the present invention, it is provided that the device additionally has a light sensor, the processing unit additionally being set up to acquire from the light sensor a first value at the first time and a second value at the second time, to determine a change between the first value and the second value of the light sensor, and, after a change that exceeds a threshold value for the light sensor, to control the communication unit in such a way that this unit sends out the first signal.

Here it is advantageous that on the basis of the first signal it can be recognized when the light intensity acting on the object being monitored exceeds a defined deviation from a target value. Such a deviation is in turn an indication of an attempted theft, in which the object is for example being packed up or removed from a building. If this is recognized, external actions can correspondingly be taken to protect the object.

A further advantageous embodiment of the present invention provides that the processing unit is set up to control the communication unit in such a way that this unit sends out the first signal after at least two changes that exceed the threshold values for the respective sensors.

Here it is advantageous that a plausibilization takes place. Thus, the alarm is not issued until at least two of the sensors detect a motion, or a motion can be inferred through the evaluation thereof. In this way, the probability of a false alarm is reduced.

According to a further advantageous embodiment of the present invention, it is provided that the processing unit is set up to be awakened from an energy-saving sleep state during the monitoring phase, via an interrupt signal, by one of the sensors or also by the communication unit, or also by an internal timer.

Here it is advantageous that the processing unit can be kept in an energy-saving state for as long a time duration as possible. This can reduce the energy consumption of the device. This is advantageous in particular in a device that is supplied with power by an energy storage unit, in order to reduce the load on the energy storage unit.

In an advantageous specific embodiment of the present invention, it is provided that the communication unit is set up to send out the first signal electrically and/or electromagnetically.

Here it is advantageous that the first signal can be received by an external device, which can thereupon infer an attempted theft based on the first signal, or can infer a risk to the object being monitored through excessive exposure to light, and can for example communicate this to security personnel or the police.

In a further advantageous specific embodiment of the present invention, it is provided that the communication unit is set up to output the first signal acoustically and/or optically.

Here it is advantageous that the first signal can be received directly in the surrounding environment of the device. In addition, the first signal can be received directly by a person without further technical assistance.

In an advantageous specific embodiment of the present invention, it is provided that the processing unit is set up to receive, in particular via the communication unit, a fourth signal that signals the end of the monitoring phase, in order to switch off the device or to change over to a different operating state.

Here it is advantageous that upon reception of the fourth signal the device can be shut off or put into a different operating state. This can be used for example to transport or to clean the object being monitored without triggering an alarm. Alternatively, this can be used to change back to the training phase in order to update the first values for the target state of the device.

In an advantageous specific embodiment of the present invention, it is provided that the processing unit is set up to send out a fifth signal, in particular via the communication unit, when the device is functioning normally.

Here it is advantageous that the fifth signal can be received by an external device or can be monitored by a person. In this way, it can be checked whether the device, and in particular all the sensors, are still functioning properly. This would for example detect an attempt to manipulate the device by cutting off one of the sensors.

In an advantageous specific embodiment of the present invention, it is provided that the device has an energy storage unit.

Here it is advantageous that due to the energy storage unit, the device does not have to rely on wire-bound power supply. In this way, the device can be attached wirelessly to a movable object that is to be monitored. Moreover, it is then not necessary to ensure that a supply of power is situated in the vicinity of the object.

In addition, the present invention relates to a method for theft detection that is executed on a device according to the present invention, having the following method steps:
a. Acquisition and storage of a respective first value of each motion sensor at a first time;
b. Acquisition and storage of a respective second value of each motion sensor at a second time;
c. Determination of the change between the first value and the second value for each of the motion sensors;
d. Outputting a first signal if at least one of the determined changes is greater than a threshold value for the respective motion sensor.

Here it is advantageous that the at least one second motion sensor increases the probability that an attempted theft is recognized. Thus, for example the first motion sensor can detect an acceleration in the three spatial directions, whereas the second motion sensor is realized as a gyro sensor that can detect a rotational motion. In this way, both a linear motion and a circular motion of the object to which the device according to the present invention is attached are recognized. Alternatively, the second motion sensor can also be realized as a magnetic field sensor or as a pressure sensor, or the device can have these two sensors as third and fourth motion sensor.

In an advantageous embodiment of the method according to the present invention, it is provided that method step a is not carried out until a second signal has been received that signals a training phase. In addition, it is provided that second method step b is not carried out until a third signal signaling the start of the monitoring phase, and subsequently an interrupt signal, has been received from one of the sensors or from the communication unit or from an internal timer. Here it is advantageous that via the second and third signal a training phase and a monitoring phase are recognized, and thus it is possible to change from one to the other. In addition, due to the interrupt the device does not have to be awakened from an energy-saving sleep state more often than is necessary.

According to an advantageous embodiment of the method according to the present invention, it is provided that in addition in method step a a first value of a light sensor is acquired at the first time and is stored, and in method step b a second value of the light sensor is acquired at the second time and is stored, and in method step c the change between the first value and the second value of the light sensor is determined, and in method step d the first signal is outputted if the change is greater than a threshold value for the light sensor.

Here it is advantageous that on the basis of the first signal it can be recognized when the light intensity acting on the monitored object exceeds a defined deviation from a target value. Such a deviation is an indication of an attempted theft, in which the object is for example being packed up or removed from a building. If this is recognized, external actions can correspondingly be taken to protect the object.

In an advantageous embodiment of the method according to the present invention, it is provided that in method step d the first signal is outputted only if at least two of the changes are greater than the threshold values of the respective sensors.

Here it is advantageous that a plausibilization takes place. Thus, the alarm is issued only if at least two of the sensors detect a motion.

According to a further advantageous embodiment of the method according to the present invention, it is provided that in addition the following method step is carried out:
e. Termination of the method or changing to a different operating mode if a fourth signal has been received that represents the end of the monitoring phase.

Here it is advantageous that when the fourth signal is received the device can be shut off or put into a different operating state. This can be used for example to transport the object or to perform maintenance on the object without triggering an alarm.

### BRIEF DESCRIPTION OF THE DRAWINGS

FIG. 1 shows an exemplary embodiment of a device according to the present invention.

FIG. 2 shows an exemplary embodiment of a method according to the present invention.

### DETAILED DESCRIPTION OF EXAMPLE EMBODIMENTS

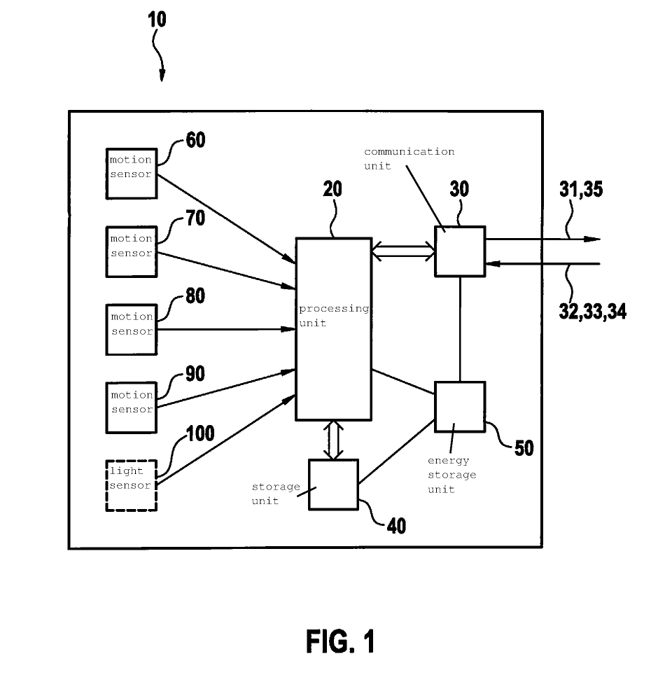

FIG. 1 shows an exemplary embodiment of a device according to the present invention. Shown is device 10, having a processing unit 20. Processing unit 20 is for example a microcontroller. In addition, device 10 can have a first motion sensor 60, a second motion sensor 70, a third motion sensor 80, and a fourth motion sensor 90. These motion sensors 60, 70, 80, and 90 preferably have different sensor designs, and here are for example an acceleration sensor 60, a gyro sensor 70, a magnetic field sensor 80, and a pressure sensor 90. Acceleration sensor 60 can detect a linear motion, and gyro sensor 70 can detect a circular motion. In addition, magnetic field sensor 80 can detect a change in position that is noticeable as a change in the magnetic field. In addition, pressure sensor 90 can detect a motion that results in a corresponding change in location, for example from an upper floor to the ground floor; a very sensitive pressure sensor can even recognize a change in height of a few centimeters. Specifically, acceleration sensor 60, gyro sensor 70, and magnetic field sensor 80 are realized with three axes in order to cover all motion profiles of the device as well as possible. Optionally, device 10 also has a light sensor 100. Sensors 60, 70, 80, 90, and 100 are connected to processing unit 20, and in this way can communicate data, in particular measurement values, to processing unit 20. In addition, device 10 has a communication unit 30 and a storage unit 40. Device 10 can also have an energy storage unit 50. Communication unit 30 is connected to processing unit 20, thus enabling a bidirectional exchange of data. Moreover, communication unit 30 is set up to send out a first signal 31, as well as, optionally, to receive a second signal 32, a third signal 33, or also a fourth signal 34. Optionally, communication unit 30 is in addition set up to send out a fifth signal 35. For the sending out of first signal 31 and fifth signal 35, communication unit 30 has for example a transmit unit (not shown graphically) that can send out the signal electrically or also electromagnetically. In this way, a wire-bound or wireless transmission of the signal can be achieved. Alternatively, but also not shown graphically, communication unit 30 has an additional output unit that can output first signal 31 and fifth signal 35 optically or also acoustically. Such an output unit has for this purpose for example a loudspeaker or a light source or a display. Storage unit 40 is connected to processing unit 20, and processing unit 20 can both write data to storage unit 40 and read data from storage unit 40. Here, data for storage unit 40 may include both the values of sensors 60, 70, 80, 90, and 100, and also threshold values for the respective sensors. Energy storage unit 50 is standardly connected to all components of device 10 that require energy in order to function.

In an alternative exemplary embodiment (not shown), energy storage unit 50 is replaced by a wire-bound power terminal.

Also not shown is the fastening of the device in or on the object to be monitored. Thus, it is possible that the device can be integrated in the frame of a painting or in the pedestal of a bust, making mechanical access from outside, in particular by unauthorized persons, significantly more difficult. In addition, as a result the device is not visible from the outside. However, if such an integration is not possible, the device can also be connected to the monitored device with a nonpositive fit.

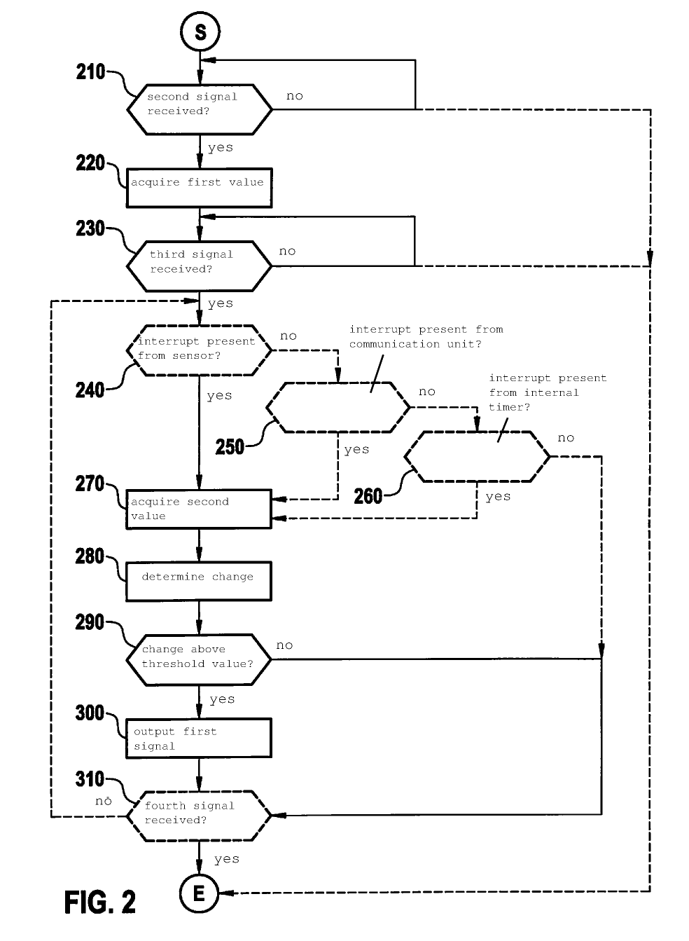

FIG. 2 shows an exemplary embodiment of a method according to the present invention. In the method, after start S a method step 210 is carried out. In this method step 210, it is checked whether a second signal 32 has already been received. Second signal 32 signals the start of a training phase. If second signal 32 has not yet been received, method step 210 is repeated after a period of time. Alternatively, the method can also terminate here. If on the other hand second signal 32 has been received, then in a method step 220 a first value is acquired at a first time from each motion sensor 60, 70, 80, and 90, and is stored. These first values represent device 10 in the target state, and are used to initialize this device 10. Subsequently, in a method step 230 it is checked whether a third signal 33 has already been received. This third signal 33 signals the start of a monitoring phase. The time span between method step 220 and method step 230 is chosen to be large enough to give the user enough time to communicate the start of the monitoring phase to the device. If third signal 33 has not been received, method step 230 is repeated after a certain time duration. Alternatively, the method can also be terminated here. If on the other hand third signal 33 has been received, then it is optionally checked, successively, whether an interrupt signal from various sources is present. For this purpose, first, in a method step 240, it is checked whether at least one interrupt is present from one of the motion sensors 60, 70, 80, or 90. Subsequently, in a method step 250 it is checked whether an interrupt is present from communication unit 30, which unit receives the command for an interrupt from the outside. It is then checked, in a method step 260, whether an interrupt is present of an internal timer of device 10. The internal timer is for example realized in a standard manner by processing unit 20. The sequence in which the interrupts from the various sources are checked is variable. However, as soon as an interrupt from one of the sources has been detected, the other interrupts are no longer checked; rather, the method continues directly with a method step 270. In this method step 270, a second value is acquired at a second time from each motion sensor 60, 70, 80, and 90, and is stored. Subsequently, in a method step 280, the change between the first value and the second value is determined for each motion sensor 60, 70, 80, and 90. After determining the changes in method step 280, in a method step 290 the change of each motion sensor 60, 70, 80, and 90 is compared to a threshold value for each of the motion sensors 60, 70, 80, and 90. If the comparison yields the result that at least one of the changes is above one of the threshold values of the respective motion sensor 60, 70, 80, or 90, then in a method step 300 a first signal 31 is outputted. This first signal 31 signals an attempted theft and is to be understood as an alarm. Alternatively, in method step 290 it is checked whether at least two of the changes are above the respective threshold values of motion sensors 60, 70, 80, and 90, and method step 300 is carried out only if this is the case. After method step 300, a further method step 310 is optionally carried out. In this method step 310, it is checked whether a fourth signal 34 has been received that signals the end of the monitoring phase. If fourth signal 34 has been received, the method is terminated. After termination of the method, the method can be started again. If, on the other hand, fourth signal 34 has not been received, the method continues as after the positive comparison in method step 210, corresponding to the above description. Alternatively, fourth signal 34 can also include a prompt to change over to the training phase and to continue the method with method step 220.

Optionally, the above method is carried out with a device that has a light sensor 100 in addition to motion sensors 60, 70, 80, and 90. Here the method runs as described above, but has the following differences: in method step 220, in addition a first value of light sensor 100 is acquired and stored. In addition, in method step 240 it is optionally checked whether an interrupt from light sensor 100 is present. If method steps 240, 250, 260 then result in the carrying out of method step 270, in this method step 270 a second value of light sensor 100 is acquired and stored. In addition, in method step 280 the change between the first value and the second value of the light sensor is determined. In method step 290, this change is thereupon additionally compared to a threshold value of light sensor 100. If the comparison yields the result that the change is above the threshold value of light sensor 100, method step 300 is carried out and first signal 31 is sent out.

In an alternative exemplary embodiment (not shown), at least one further method step is carried out during the monitoring phase. In this step, it is checked whether all components of the device are functioning properly. If this is the case, a further method step is thereupon carried out in which a fifth signal 35 is sent out. This fifth signal 35 represents a heartbeat signal. Such a heartbeat signal can be received by an external device or by a person, and indicates that the device is still functioning correctly.

1-15. (canceled)

16. A device for theft recognition, comprising:
a processing unit;
a communication unit that is configured to at least to send out a first signal;
a first motion sensor, the first motion sensor being an acceleration sensor; and
at least one second motion sensor;
wherein the processing unit is configured to acquire, from each of the first motion sensor and the second motion sensor, a respective first value at a first time and a respective second value at a second time, and to determine, in each case, a change between the first value and the second value of each of the first motion sensor and the second motion sensor, and, after at least one change that exceeds a threshold value for the respective motion sensor, to control the communication unit in such a way that the control unit sends out the first signal.

17. The device as recited in claim 16, wherein the processing unit is configured to receive, via the communication unit, a second signal that signals the start of a training phase and a third signal that signals the start of a monitoring phase, the first time being within the training phase and the second time being within the monitoring phase.

18. The device as recited in claim 16, further comprising:
a light sensor;
wherein the processing unit is configured to acquire a first value at a first time and a second value at a second time from the light sensor, to determine a change between the first value of the light sensor and the second value of the light sensor, and, after a change that exceeds a threshold value for the light sensor, to control the communication unit to send out the first signal.

19. The device as recited in claim 16, wherein the processing unit is configured to control the communication unit to send out the first signal only after at least two changes that exceed the threshold value for the at least one of the first motion sensor and the second motion sensor.

20. The device as recited in claim 17, wherein the processing unit is configured to be awakened from an energy-saving sleep state during the monitoring phase, via an interrupt signal, at least one of: (i) by one of the first motion sensor and second motion sensor, (ii) by the communication unit, and (iii) by an internal timer.

21. The device as recited in claim 16, wherein the communication unit is configured to send out the first signal at least one of electrically and electromagnetically.

22. The device as recited in claim 16, wherein the communication unit is configured to output the first signal at least one of acoustically and optically.

23. The device as recited in claim 17, wherein the processing unit is configured to receive, via the communication unit, a fourth signal that signals the end of the monitoring phase, in order to switch off the device or to change over to a different operating state.

24. The device as recited in claim 16, wherein the processing unit is configured to send out, via the communication unit, a fifth signal when the device is functioning correctly.

25. The device as recited in claim 16, wherein the device has an energy storage unit.

26. A method for theft recognition that runs on a device, the device including a processing unit, a communication unit that is configured to at least to send out a first signal, a first motion sensor, the first motion sensor being an acceleration sensor, and at least one second motion sensor, the method comprising:
a. acquiring and storing a respective first value of each of the first motion sensor and the second motion sensor at a first time,
b. acquiring and storing a respective second value of each of the first motion sensor and the second motion sensor at a second time,
c. determining a change between the first value and the second value for each of the first motion sensor and the second motion sensor; and
d. outputting a first signal if at least one of the determined changes is greater than a threshold value for the respective motion sensor.

27. The method as recited in claim 26, wherein method step a is carried out after a second signal has been received that signals a training phase, and second method step b is carried out after a third signal has been received that signals the start of the monitoring phase and subsequently an interrupt has been received from one of: (i) one of the first motion sensor or the second motion sensor, (ii) the communication unit, and (iii) an internal timer.

28. The method as recited in claim 26, wherein in addition in method step a, a first value of a light sensor is acquired at the first time and is stored, and in method step b a second value of the light sensor is acquired at the second time and is stored, and in method step c the change between the first value and the second value of the light sensor is determined, and in method step d the first signal is output when the change is greater than a threshold value for the light sensor.

29. The method as recited in claim 26, wherein in method step d the first signal is outputted if at least two of the changes are greater than the threshold values of the respective sensors.

30. The method as recited in claim 26, further comprising:
e. terminating the method or changing over to a different operating mode if a fourth signal has been received that signals an end of the training phase.
